(19) United States
(12) Patent Application Publication
(10) Pub. No.: US 2012/0194709 A1
(43) Pub. Date: Aug. 2, 2012

(54) IMAGE PICKUP APPARATUS

(75) Inventor: Masahiro YOKOHATA, Osaka City (JP)

(73) Assignee: SANYO Electric Co., Ltd., Moriguchi City (JP)

(21) Appl. No.: 13/362,572

(22) Filed: Jan. 31, 2012

(30) Foreign Application Priority Data
Jan. 31, 2011 (JP) 2011-018465

(51) Int. Cl. H04N 5/262; H04N 5/232

(52) U.S. Cl. 348/240.3; 348/E05.045; 348/E05.055

(57) ABSTRACT

An image pickup apparatus includes an input image generating portion that generates an input image from an optical image of a subject entering through a zoom lens, and an output image generating portion that generates an output image by adjusting a focused state of the input image by image processing when an optical zoom magnification is changed by a positional change of the zoom lens.

### CROSS-REFERENCE TO RELATED APPLICATIONS

This nonprovisional application claims priority under 35 U.S.C. §119(a) on Patent Application No. 20114J18465 flied in Japan on Jan. 31, 2011, the entire contents of which are hereby incorporated by reference.

### BACKGROUND OF THE INVENTION

1. Field of the Invention

The present invention relates to an image pickup apparatus such as a digital camera.

2. Description of Related Art

An image pickup apparatus such as a digital camera usually has an optical zoom function, and a user can change an optical zoom magnification by zoom operation so that an imaging angle of view can be adjusted.

Note that there is proposed a method in which after taking an image, a focused state of the taken image can be adjusted by image processing.

Here, a change of the optical zoom magnification is accompanied with a change of an optical characteristic of an image pickup portion. Therefore, when the optical zoom magnification is changed, a focused state (including a depth of field) of the taken image is also changed. After adjusting the focused state of the taken image to a desired state by setting an aperture value or the like, the user may change the optical zoom magnification for adjusting a composition. In this case, it is not preferred that the focused state of the taken image is changed from the user's desired state along with the change of the optical zoom magnification.

### SUMMARY OF THE INVENTION

An image pickup apparatus according to the present invention, includes an input image generating portion that generates an input image from an optical image of a subject entering through as zoom lens, and an output image generating portion that generates an output image by adjusting a focused state of the input image by image processing when an optical zoom magnification is changed by a positional change of the zoom lens.

### BRIEF DESCRIPTION OF THE DRAWINGS

FIG. 1 is a schematic general block diagram of an image pickup apparatus according to an embodiment of the present invention.

FIG. 2 is an internal structural diagram of the image pickup portion of FIG. 1.

FIGS. 3A to 3D are diagrams illustrating meanings of focusing, a depth of field, a subject distance, and the like.

FIG. 4 is a block diagram of portions related particularly to achievement of Characteristic action in the image pickup apparatus of FIG. 1.

FIG. 5A is a diagram illustrating an input image, and FIG. 5B is a diagram illustrating blur characteristic of the input image.

FIG. 6 is a diagram illustrating a distance map corresponding to the input image of FIG. 5A.

FIG. 7 is a diagram illustrating a positional relationship among the image pickup apparatus and a plurality of subjects.

FIG. 8 is a diagram illustrating a positional relationship among the image pickup apparatus and a plurality of subjects.

FIG. 9 is a diagram illustrating blur characteristic of the input image.

FIG. 10 is a diagram illustrating an input image and an output image before and after a zoom operation.

FIG. 11A is a diagram illustrating the input image after increasing an optical zoom magnification, and FIG. 11B is a diagram illustrating blur characteristic of the input image.

FIG. 12A is a diagram illustrating a focused state adjusted image, and FIG. 12B is a diagram illustrating blur characteristic of the focused state adjusted image.

FIG. 13 is a diagram illustrating the input image before and after increasing the optical zoom magnification, the focused suite adjusted image based on the input image after increasing the optical zoom magnification, and blur characteristics of the images.

FIG. 14 is a diagram illustrating a distance map corresponding to the input image of FIG. 11A.

FIG. 15 is a diagram illustrating the depth of field of the input image before and after increasing the optical zoom magnification, and the depth of field of the focused state adjusted image based on the input in after increasing the optical zoom magnification.

FIG. 16 is a diagram in which set instruction timing of a designated depth of field is added to FIG. 10.

FIG. 17 is a flowchart of an action according to a first example of the present invention.

FIG. 18 is a diagram illustrating a manner in which a process target region is set in the input image after increasing the optical zoom magnification, according to a third example of the present invention.

FIG. 19A is a diagram illustrating an input image after decreasing the optical zoom magnification according to a fourth example of the present invention, and FIG. 19B is a diagram illustrating blur characteristic of the input image.

FIG. 20 is a diagram illustrating a distance map corresponding to the input image of FIG. 19A.

FIG. 21 is a diagram illustrating a manner in which a process target region is set in the input image after decreasing the optical zoom magnification according to the fourth example of the present invention.

FIG. 22A is a diagram illustrating a focused state adjusted image according to the fourth example of the present invention, and FIG. 22B is a diagram illustrating blur characteristic of the focused state adjusted image.

### DETAILED DESCRIPTION OF THE PREFERRED EMBODIMENTS

Hereinafter, examples of an embodiment of the present invention are described specifically with reference to the attached drawings. In the drawings to be referred to, the same part is denoted by the same numeral or symbol, and overlapping description of the same part is omitted as a rule. Note that in this specification, for simple description, a name of information, physical quantity; state quantity, a member or the like corresponding to the numeral or symbol may be shortened or omitted by adding the numeral or symbol referring to the information, the physical quantity, the state quantity, the member or the like. For instance, when a focus reference distance is denoted by symbol Lo, the focus reference distance Lo may be expressed by a distance Lo or simply by Lo. When a focused state adjusting portion is denoted by numeral 57, the focused state adjusting portion 57 may be expressed by an adjusting portion 57.

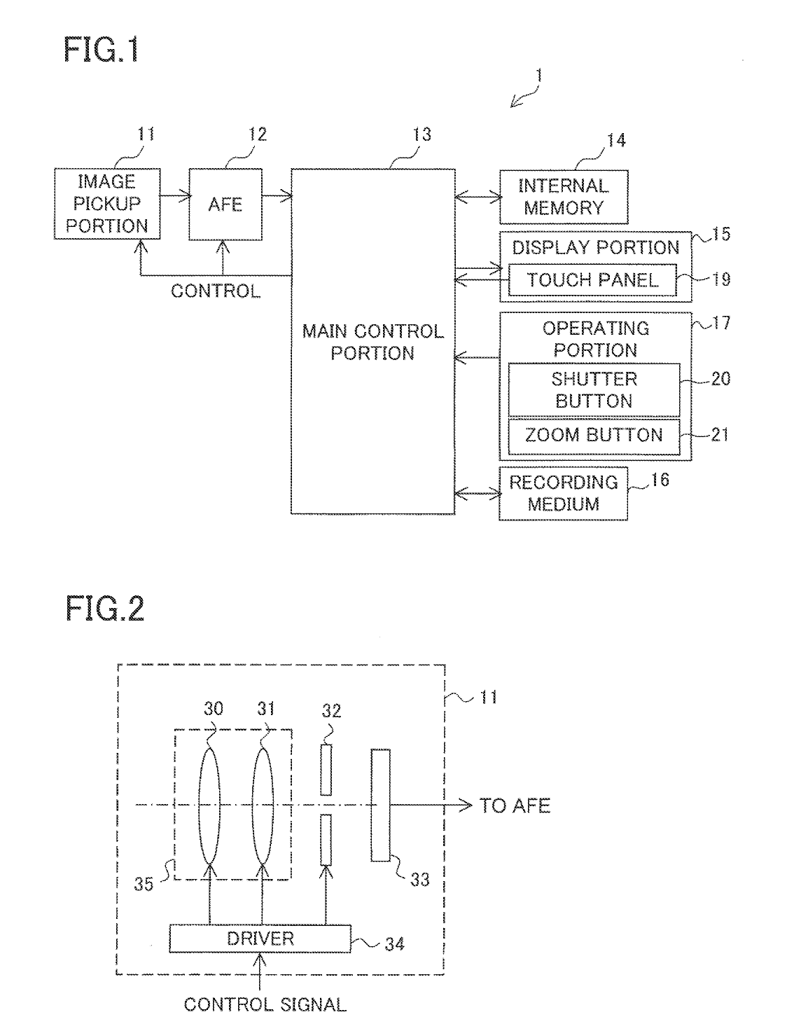

FIG. 1 is a schematic general block diagram of an image pickup apparatus 1 according to an embodiment of the present invention. The image pickup apparatus 1 is a digital video camera that can take and record still images and moving images. However, the image pickup apparatus 1 may be a digital still camera that can take and record only still images. In addition, the image pickup apparatus 1 may be one that is incorporated in a mobile terminal such as a mobile phone.

The image pickup apparatus 1 includes an image pickup portion 11, an analog front end (AFT) 12, a main control portion 13, an internal memory 14, a display portion 15, a recording medium 16, and an operating portion 17. Note that the display portion 15 can be interrupted to be disposed in an external device (not shown) of the image pickup apparatus 1.

The image pickup portion 11 photographs a subject using an image sensor. FIG. 2 is an internal structural diagram of the image pickup portion 11. The image pickup portion 11 includes an optical system 35, an aperture stop 32, an image sensor (solid-state image sensor) 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 for adjusting an angle of view of the image pickup portion 11 and a focus lens 31 for focusing. The zoom lens 30 and the focus lens 31 can move in an optical axis direction. Based on a control signal from the main control portion 13, positions of the zoom lens 30 and the focus lens 31 in the optical system 35 and an opening degree of the aperture stop 32 are controlled.

The image sensor 33 is constituted of a plurality of light receiving pixels arranged in horizontal and vertical directions. The light receiving pixels of the image sensor 33 perform photoelectric conversion of an optical image of the subject entering through the optical system 35 and the aperture stop 32, so as to deliver an electric signal obtained by the photoelectric conversion to the analog front end CAFE) 12.

The AFE 12 amplifies an analog signal output from the image pickup portion 11 (image sensor 33) and converts the amplified analog signal into a digital signal so as to deliver the digital signal to the main control portion 13. An amplification degree of the signal amplification in the AFE 12 is controlled by the main control portion 13. The main control portion 13 performs necessary image processing on the image expressed by the output signal of the AFE 12 and generates an image signal (video signal) of the image after the image processing. The main control portion 13 also has a function as a display control portion that controls display content of the display portion 15 so as to perform control necessary for the display on the display portion 15.

The internal memory 14 is constituted of a synchronous dynamic random access memory (SDRAM) or the like and temporarily stores various data generated in the image pickup apparatus 1.

The display portion 15 is a display device having a display screen such as a liquid crystal display panel so as to display taken images or images recorded in the recording medium 16 under control of the main control portion 13. In this specification, when referred to simply as a display or a display screen, it means the display or the display screen of the display portion 15. The display portion 15 is equipped with a touch panel 19, so that a user can issue a specific instruction to the image pickup apparatus 1 by touching the display screen of the display portion 15 with a touching member (such as a finger or a touch pen). Note that it is possible to omit the touch panel 19.

The recording medium 16 is a nonvolatile memory such as a card-like semiconductor memory or a magnetic disk so as to record an image signal of the taken image under control of the main control portion 13. The operating portion 17 includes a shutter button 20 for receiving an instruction to take a still image and a zoom button 21 for receiving an instruction to change a zoom magnification, so as to receive various operations from the outside. Operational content of the operating portion 1 is sent to the main control portion 13. The operating portion 17 and the touch panel 19 can be called a user interface for receiving user's arbitrary instruction and operation. The shutter button 20 and the zoom button 21 may be buttons on the touch panel 19.

Action modes of the image pickup apparatus 1 includes a photographing mode in which images (still images or moving images) can be taken and recorded, and a reproducing mode in which images (still images or moving images) recorded in the recording medium 16 can be reproduced and displayed on the display portion 15. Transition between the modes is performed in accordance with an operation to the operating portion 17.

In the photographing mode, a subject is photographed periodically at a predetermined frame period so that taken images of the subject are sequentially obtained. An image signal expressing an image is also referred to as image data. The image signal contains a luminance signal and a color difference signal, for example. Image data of a certain pixel may be also referred to as a pixel signal. A size of a certain image or a size of an image region may be referred to as an image size. An image size of a noted image or a noted image region can be expressed by the number of pixels forming the noted image or the number of pixels belonging to the noted image region. Note that in this specification, image data of a certain image may be referred to simply as an image. Therefore, generation, recording, processing, editing, or storing of an input image means generation, recording, processing, editing, or storing of image data of the input image.

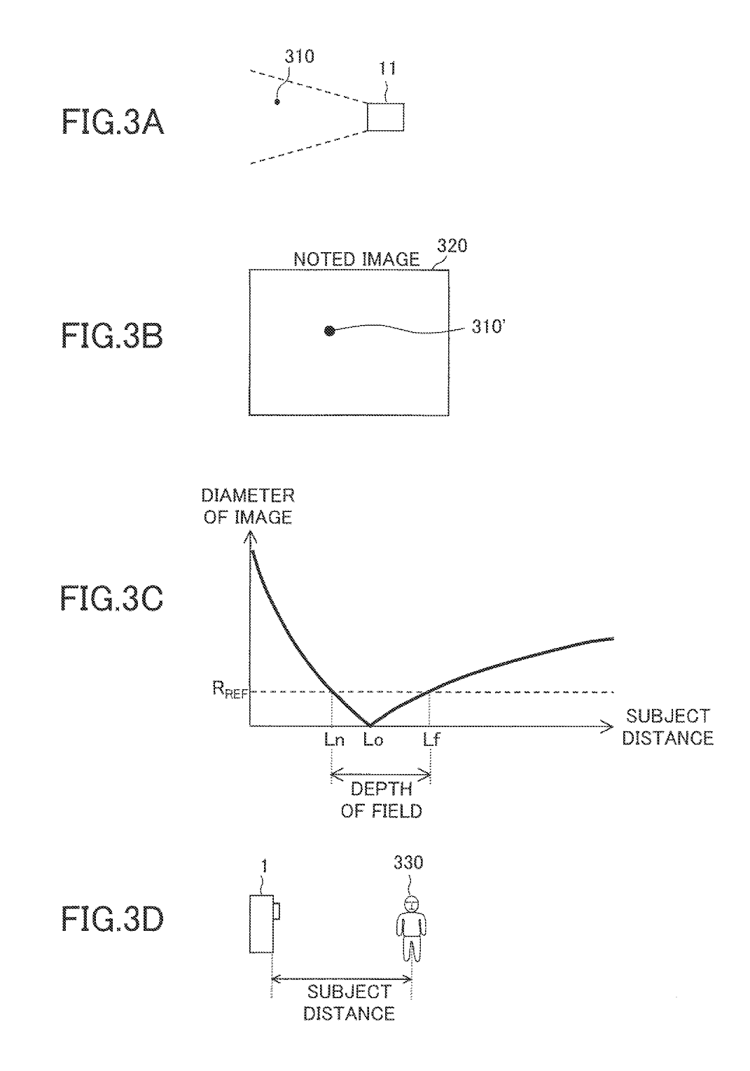

With reference to FIGS. 3A to 3D, meanings of focusing and the like are described. As illustrated in FIG. 3A, it is supposed that an ideal point light source 310 is included as a subject in a photographing range of the image pickup portion 11. In the image pickup portion 11, incident light from the point light source 310 forms an image at an imaging point by the optical system 35. If the imaging point is on an imaging surface of the image sensor 33, a diameter of the image of the point light source 310 on the imaging surface is substantially zero and is smaller than a permissible diameter of circle of confusion of the image sensor 33. On the other hand, if the imaging paint is not on the imaging surface of the image sensor 33, the optical image of the point light source 310 is blurred on the imaging surface. As a result, the diameter of the image of the point light source 310 on the imaging surface can be larger than the permissible diameter of circle of confusion. If the diameter of the image of the point light source 310 on the imaging surface is the permissible diameter of circle of confusion or smaller, the subject as the point light source 310 is focused on the imaging surface. If the diameter of the image of the point light source 310 on the imaging surface is larger than the permissible diameter of circle of confusion, the subject as the point light source 310 is not focused on the imaging surface.

In similar consideration, as illustrated in FIG. 3B, if an image 310 of the point light source 310 is included as a subject image in a noted image 320 as an arbitrary two-dimensional image, and if a diameter of the image 310′ is smaller than or equal to a reference diameter R_{REF} corresponding to the permissible diameter of circle of confusion, the subject as the point light source 310 is focused in the noted image 320. If the diameter of the image 310′ is larger than the reference diameter R_{REF}, the subject as the point light source 310 is not focused in the noted image 320. The reference diameter R_{REF} is the permissible diameter of circle of confusion in the noted image 320. In the noted image 320, a subject that is focused is referred to as a focused subject, and a subject that is not focused is referred to as an out-of-focus subject. In the entire image region of the noted image 320, an image region where image data of the focused subject exists is referred to as a focused region, and an image region where image data of the out-of-focus subject exists is referred to as an out-of-focus region.

In addition, an indicator corresponding to the diameter of the image 310′ is referred to as a focus degree. In the noted image 320, as the diameter of the image 310′ is larger, the focus degree of the subject as the point light source 310 (namely, the focus degree of the image 310) is lower. As the diameter of the image 310′ is smaller, the focus degree of the subject as the point light source 310 (namely; the focus degree of the image 310′) is higher. Therefore, the focus degree in the out-of-focus region is lower than the focus degree in the focused region. Note that an arbitrary image mentioned in this specification is a two-dimensional image unless otherwise noted.

A distance in the real space between an arbitrary subject 330 and the image pickup apparatus 1 (more specifically, the image sensor 33) is referred to as a subject distance (see FIG. 3D). If the arbitrary subject 330 is positioned in the depth of field of the noted image 320 (namely, if the subject distance of the subject 330 is within the depth of field of the noted image 320), the subject 330 is a focused subject in the noted image 320. If the subject 330 is not positioned in the depth of field of the noted image 320 (namely, if the subject distance of the subject 330 is not within the depth of field of the noted image 320), the subject 330 is an out-of-focus subject in the noted image 320.

As illustrated in FIG. 3C, a range of the subject distance in which the diameter of the image 310′ is the reference diameter R_{REF} or smaller is the depth of field of the noted image 320. A focus reference distance Lo, a near point distance Ln, and a far point distance Lf of the noted image 320 are within the depth of field of the noted image 320. A subject distance corresponding to a minimum value of the diameter of the image 310′ is the focus reference distance Lo of the noted image 320. A minimum distance and a maximum distance in the depth of field of the noted image 320 are the near point distance Ln and the far point distance Lf, respectively. A length between the near point distance Ln and the far point distance Lf is referred to as a magnitude of the depth of field.

In the following description, an action of the image pickup apparatus 1 in the photographing mode and a structure of the image pickup apparatus 1 that functions effectively in the photographing mode are described, unless otherwise noted.

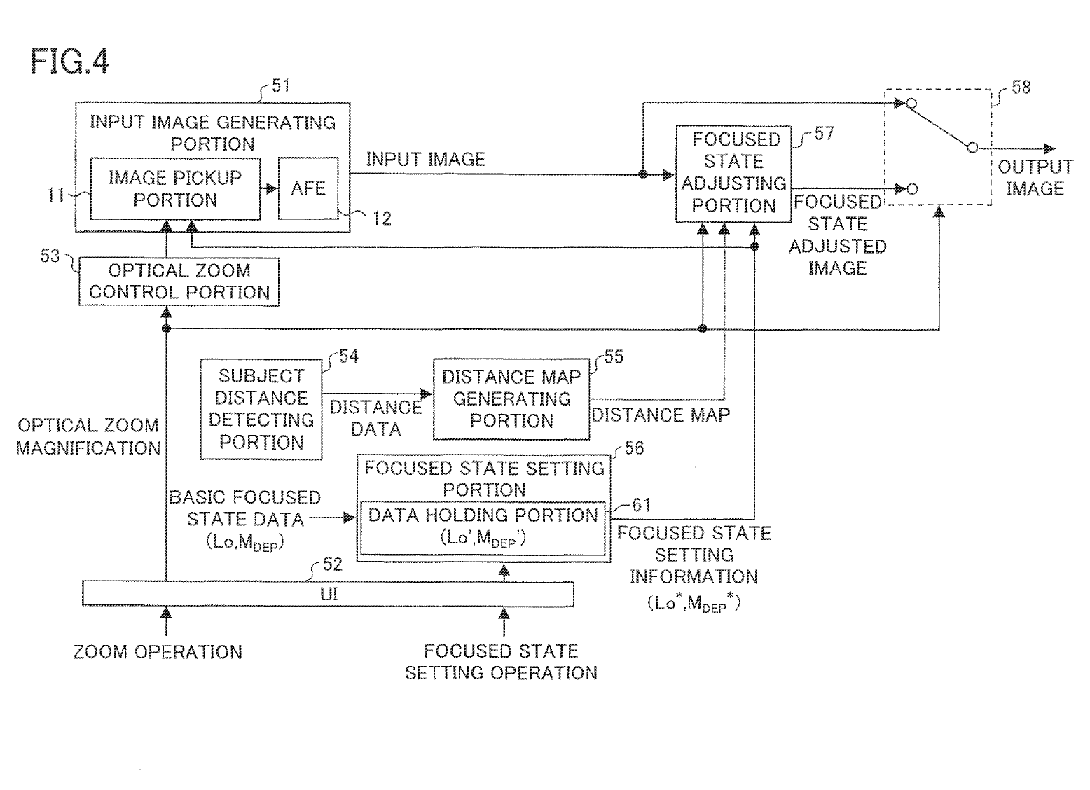

FIG. 4 is a block diagram of portions related particularly to achievement of characteristic action in the image pickup apparatus 1. The portions denoted by numerals 51 to 58 are disposed in the image pickup apparatus 1. The input image generating portion 51 includes the image pickup portion 11 and the AFE 12, while the user interface 52 (hereinafter referred to simply as UI 52) includes the operating portion 17 and the touch panel 19 (see FIG. 1). The portions denoted by numerals 53 to 58 can be disposed in the main control portion 13, for example.

The input image generating portion 51 generates an input image based on the output signal of the AFE 12. The input image is a still image generated from the output signal of the AFE 12 of one frame period. The input image is obtained by performing a predetermined image processing (such as a demosaicing process and a noise reduction process) on the output signal of the AFE 12 of one frame period, but the output signal of the AFE 12 itself may be generated as the image data of the input image.

The UI 52 receives user's various operations including a zoom operation and a focused state setting operation. The zoom operation is an operation for designating an optical zoom magnification of the image pickup portion 11, and the optical zoom magnification of the image pickup portion 11 is changed in accordance with the zoom operation. Therefore, the zoom operation corresponds to user's instruction to change the optical zoom magnification. Note that if the image pickup apparatus 1 is equipped with a digital zoom function, the zoom operation can function as an operation to designate a digital zoom magnification. However, in the following description, existence of the digital zoom function is neglected. Meaning of the focused state setting operation will be apparent from the later description.

The optical zoom control portion 53 controls a position of the zoom lens 30 so that the input image is taken by an optical zoom magnification designated by the zoom operation. The optical zoom magnification is changed by changing a position of the zoom lens 30. As known well, the angle of view of the image pickup portion 11 when taking an image (namely, an angle of view of the input image) is decreased along with an increase of the optical zoom magnification and is increased along with a decrease of the optical zoom magnification.

The subject distance detecting portion 54 detects a subject distance of a subject in each pixel in the input image by subject distance detecting process, so as to generate distance data expressing the detection result (a detected value of the subject distance of the subject at each pixel of the input image). As a method of detecting the subject distance, arbitrary methods including known methods can be used. For instance, the subject distance may be measured by using a stereo camera or a range sensor, or the subject distance may be determined by an estimation process using edge information in the input image.

The distance map generating portion 55 generates a distance map based on distance data generated by the subject distance detecting portion 54. The distance map is a range image (distance image) in which each pixel value has the detected value of the subject distance. The distance map specifies a subject distance of a subject at an arbitrary pixel in the input image or an image based on the input image (the focused state adjusted image or the output image described later). Note that the distance data itself may be the distance map. In this case, the distance map generating portion 55 is not necessary.

The focused state setting portion 56 is supplied with basic focused state data. The basic focused state data is data specifying the focus reference distance Lo and the magnitude of the depth of field in the input image (see FIG. 3C). Hereinafter, the magnitude of the depth of field is denoted by symbol M_{DEP} and is referred to as a depth M_{DEP}. For instance, a focal length, an aperture stop value and the like of the image pickup portion 11 when taking the input image are given as the basic focused state data, and the focused state setting portion 56 determines the distance Lo and the depth M_{DEP} in the input image based on the basic focused state data. The focal length is determined depending on positions of lenses in the optical system 35, and the aperture stop value is determined depending on the opening amount of the aperture stop 32.

The focused state setting portion 56 generates focused state setting information based on the distance Lo and the depth M_{DEP} in the input image or based on the focused state setting operation. The focused state setting information is information determining the distance Lo and the depth M_{DEP} of the focused state adjusted image generated by the focused state adjusting portion 57, and includes a set distance Lo* and a set depth M_{DEP}* as target values of the distance Lo and the depth M_{DEP} of the focused state adjusted image.

The focused state setting portion 36 is equipped with a data holding portion 61 for holding the distance Lo′ and the depth M_{DEP}′. The user can perform the focused state setting operation to the UT 52 as necessary. In the focused state setting operation, the user can designate the Lo′ and M_{DEP}′ to be held in the data holding portion 61. When the focused state setting operation is performed, the Lo′ and M_{DEP}′ designated by the focused state setting operation are held in the data holding portion 61. The user can designate only one of the Lo′ and M_{DEP}′ in the focused state setting operation. If the Lo′ is not designated by the focused state setting operation, the data holding portion 61 can hold the distance Lo of the input image at arbitrary time point as the distance Lo′. If the M_{DEP}′ is not designated by the focused state setting operation, the data holding portion 61 can hold the depth M_{DEP} of the input image at an arbitrary time point as the depth M_{DEP}′. The focused state setting portion 56 outputs focused state setting information containing the Lo′ and M_{DEP}′ held in the data holding portion 61 as Lo* and M_{DEP}*.

Therefore, if the focused state setting operation is not performed, the Lo′ and M_{DEP}′ based on the basic focused state data are set to the Lo* and M_{DEP}*. If the Lo′ and M_{DEP}′ are designated by the focused state setting operation, the Lo′ and M_{DEP}′ based on the focused state setting operation are set to the Lo* and M_{DEP}*. When the focused state setting operation is performed, the main control portion 13 (for example, the focused state setting portion 56) can control the focal length, the aperture stop value, and the like of the image pickup portion 11 so that the distance Lo and the depth M_{DEP} of the input image obtained by photography after the focused state setting operation match the Lo* and M_{DEP}*, respectively (however, this control is not essential).

The focused state adjusting portion 57 can adjust a focused state of the input image by image processing based on the distance map. An input image after adjusting the focused state is referred to as the focused state adjusted image, and image processing for generating the focused state adjusted image from the input image is referred to as a specific image processing. The adjustment of the focused state in the specific image processing includes adjustment of the depth of field. The adjustment of the depth of field in the specific image processing includes at least adjustment of the depth M_{DEP} and may further include adjustment of the distance Lo. More specifically, the focused state adjusting portion 57 performs the specific image processing on the input image based on the distance map so that the distance Lo and the depth M_{DEP} in the focused state adjusted image respectively become the distance Lo and the depth M_{DEP} corresponding to the set distance Lo* and the set depth M_{DEP}* (ideally, the Lo and M_{DEP} in the focused state adjusted image respectively agree with the Lo* and M_{DEP}*).

The focused state adjusting portion 57 is also supplied with an optical zoom magnification value (namely, a value of the optical zoom magnification). The focused state adjusting portion 57 may be constituted so that the specific image processing is performed only when the optical zoom magnification value is changed (meaning of performing the specific image processing along with a change of the optical zoom magnification will be described later).

The selecting portion 58 selects and outputs one of the input image and the focused state adjusted image as the output image. The output image is displayed on the display portion 15 and can be recorded in the recording medium 16. The selecting action of the selecting portion 58 is performed based on the optical zoom magnification value, and detail and meaning of the selecting action will be apparent from the later description.

Here, the change of the optical zoom magnification is accompanied with a change of optical characteristic of the image pickup portion 11. Therefore, when the optical zoom magnification is changed, the focused state (depth of field) of the input image is also changed. The user may change the optical zoom magnification after setting the depth of field to a desired value. In this case, it is not preferred that the depth of field is changed from the user's desired depth of field along with the change of the optical zoom magnification. The image pickup apparatus 1 has a function of suppressing the change of the focused state (depth of field) that may be generated when the optical zoom magnification is changed, by using the portions in FIG. 4. The photographing mode in which this function is realized is referred to as a special photographing mode.

Hereinafter, with reference to FIGS. 5A and 5B and the like, an action of the image pickup apparatus 1 in the special photographing mode is described. In the following description, for convenience sake of description, it is supposed that the focus reference distance Lo is a center distance in the depth of field in the noted image 320 as an arbitrary two-dimensional image (see FIGS. 3B and 3C). In other words, it is supposed that Lo=(Ln+Lf)/2 is satisfied. The input image, the focused state adjusted image, or the output image is one type of the noted image 320. In addition, in the noted image 320, an out-of-focus distance (sec FIG. 5B) means a distance out of the depth of field of the noted image 320, and an out-of-focus distance subject means a subject positioned out of the depth of field of the noted image 320. In addition, a difference between a focus reference distance Lo and a subject distance of an arbitrary subject is referred to as a difference distance.

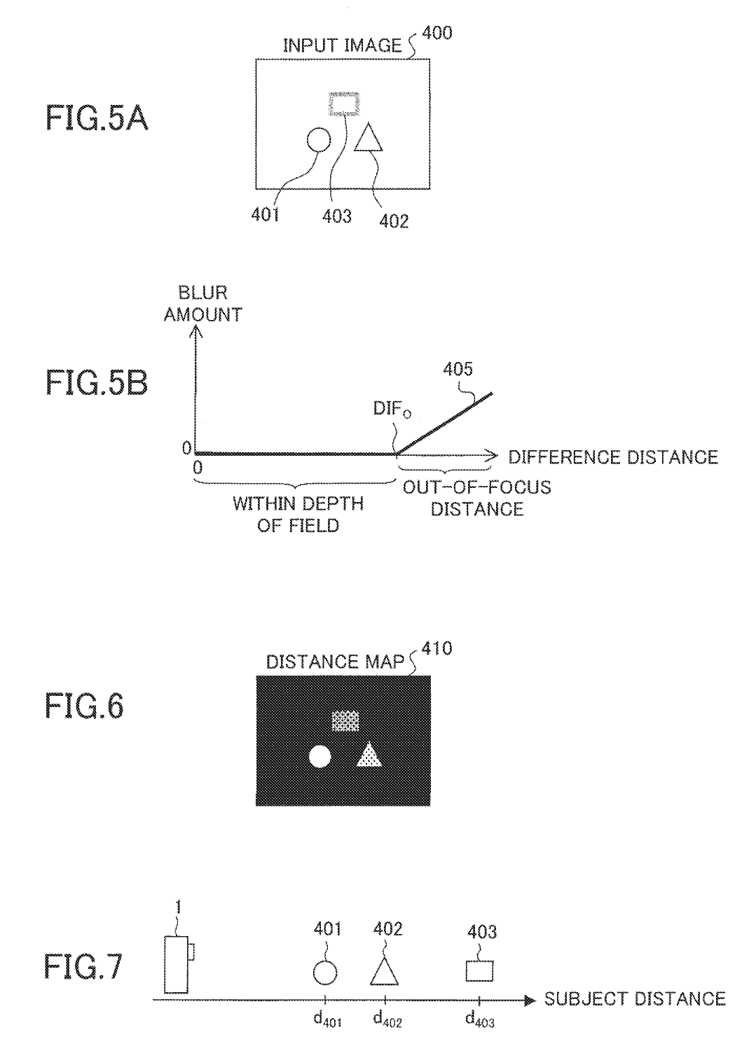

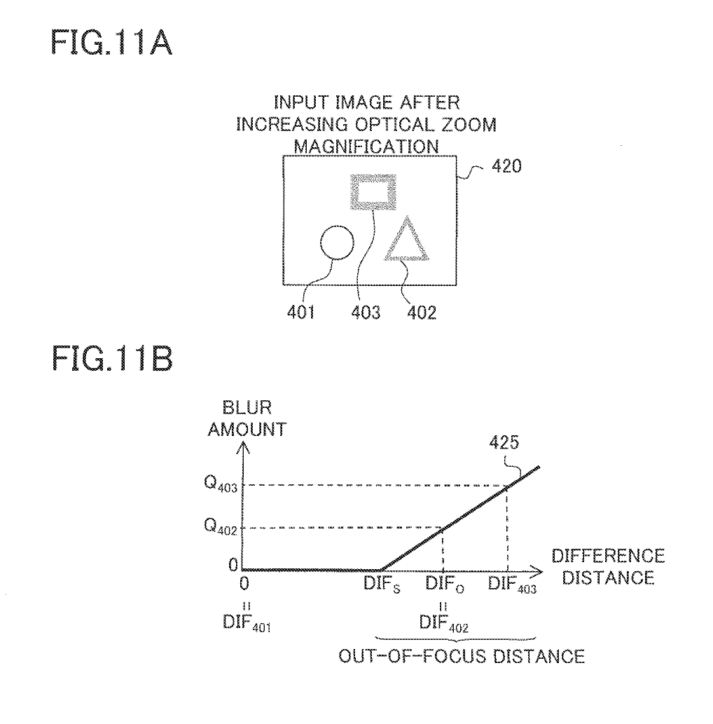

FIG. 5A illustrates an input image 400 as an example of the input image. FIG. 6 illustrates a distance map 410 obtained by performing a subject distance detecting process when the input image 400 is taken. The distance map 410 is a distance map corresponding to the angle of view of the input image 400. In the input image 400, there are image data of subjects 401, 402, and 403. As illustrated in FIG. 7, it is supposed that inequality 0<d₄₀₁<d₄₀₂<d₄₀₃ is satisfied among a subject distance d₄₀₁ of the subject 401, a subject distance d₄₀₂ of the subject 402, and a subject distance d₄₀₃ of the subject 403. In FIG. 5A, a degree of blur of the subject image is expressed by thickness of a contour line of the subject (the same is true for FIG. 11A and the like referred to later).

A bent line 405 of FIG. 5B illustrates a relationship between a blur amount and a difference distance of each subject in the input image 400. In the noted image 320, the blur amount of the noted subject means an indicator indicating a degree of blur of the noted subject in the noted image 320. As the degree of blur of the noted subject is larger, the blur amount of the noted subject is larger. In addition, as the focus degree of the noted subject is lower, the blur amount of the noted subject is larger. In this example, the noted is the subject 401, 402, or 403, for example. Therefore, for example, supposing that each of the subjects 401, 402, and 403 is an ideal point light source, diameters of the images of the subjects 401, 402, and 403 in the noted image 320 can be considered to be blur amounts of the subjects 401, 402, and 403, respectively.

A distance DIF_{O} illustrated in FIG. 5B is a half of the magnitude of the depth of field of the input image 400 (namely, DIF_{O}=(Lf−Ln)/2 holds). Here, a blur amount of a subject within the depth of field, namely, a blur amount of an image having a diameter smaller than or equal to the reference diameter R_{REF} corresponding to the permissible diameter of circle of confusion is regarded to be zero (see FIG. 3C). Then, as illustrated in FIG. 5B, in the input image 400, a blur amount of a subject having a difference distance smaller than or equal to the distance DIF_{O} is zero. In the input image 400, a blur amount of a subject having a difference distance larger than the distance DIF_{O} is larger than zero, and the blur amount of the subject having the difference distance larger than the distance DIF_{O} increases along with an increase of the difference distance. In the input image 400, the difference distance larger than the distance DIF_{O} is the out-of-focus distance.

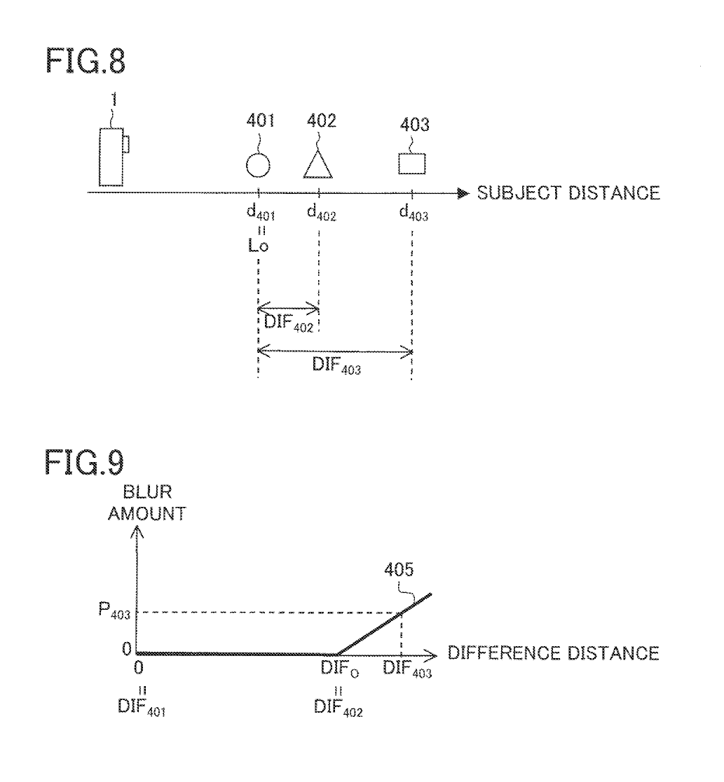

In the input image 400, difference distances of the subjects 401, 402, and 403 are expressed by DIF₄₀₁, DIF₄₀₂, and DIF₄₀₃. Then, it is supposed that as illustrated in FIGS. 8 and 9, the focus reference distance Lo of the input image 400 is equal to the subject distance d₄₀₁ (namely, DIF₄₀₁=0 holds), and that DIF₄₀₁<DIF₄₀₂=DIF_{O}<DIF₄₀₃ is satisfied. Then, in the input image 400, the subject 401 is the focused subject, and the subject 403 is the out-of-focus subject. Therefore, a blur amount of the subject 401 is zero, and a blur amount of the subject 403 is P₄₀₃ (P₄₀₃>0). In addition, because DIF₄₀₂=DIF_{O} holds, in the input image 400, the subject 402 is the used subject, and a blur amount of subject 402 is zero.

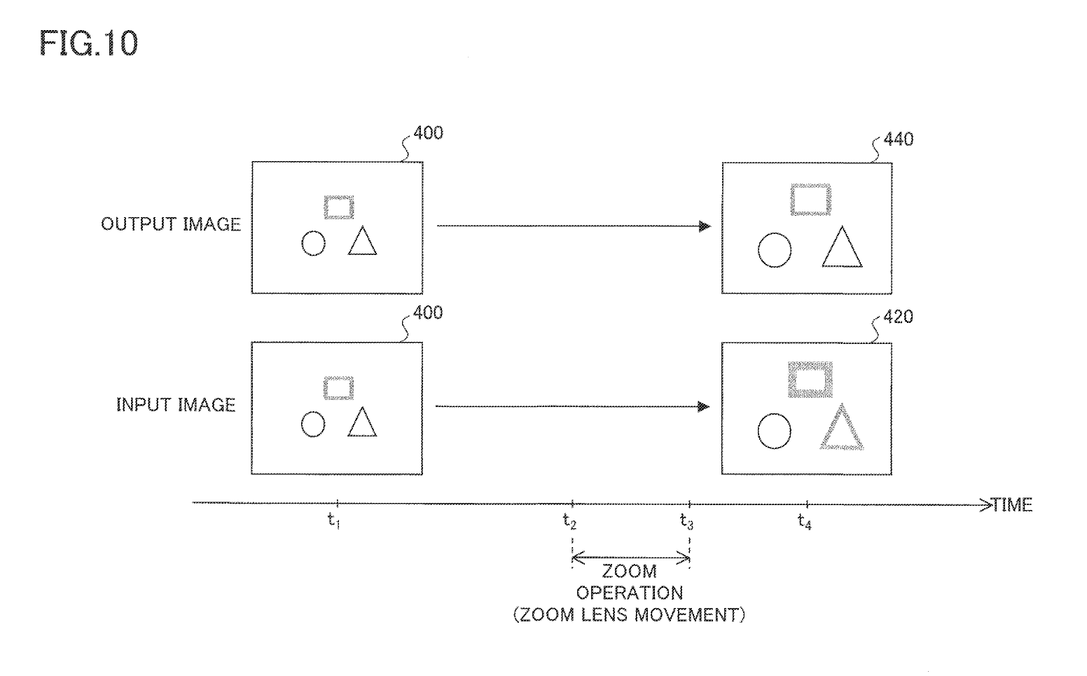

A plurality of input images including the input image 400 and arranged in time sequence are generated sequentially by photographing at a predetermined frame period. Here, as illustrated in FIG. 10, it is supposed that the input image 400 is photographed at time point t₁, and then the zoom operation is performed so that the optical zoom magnification is changed between the time points t₂ and t₃. It is supposed that time point tᵢ₊₁ is after time point tᵢ (i denotes an integer). At the time point t₁, the input image 400 is selected by the selecting portion 58 and is output from the selecting portion 58 as the output image.

An image 420 illustrated in FIGS. 10 and 11A is the input image obtained at time point t₄, namely, an input image after the optical zoom magnification is changed. However, it is supposed here that the optical zoom magnification is increased between the time points t₂ and t₃. Then, an angle of view of the input image 420 is smaller than the angle of view of the input image 400. In addition, it is supposed that a distance Lo of the input image 420 is also equal to the subject distance d₄₀₁ similarly to the distance Lo of the input image 400 by position adjustment of the focus lens 31 after changing the optical zoom magnification. An image 440 illustrated in FIG. 10 will be described later.

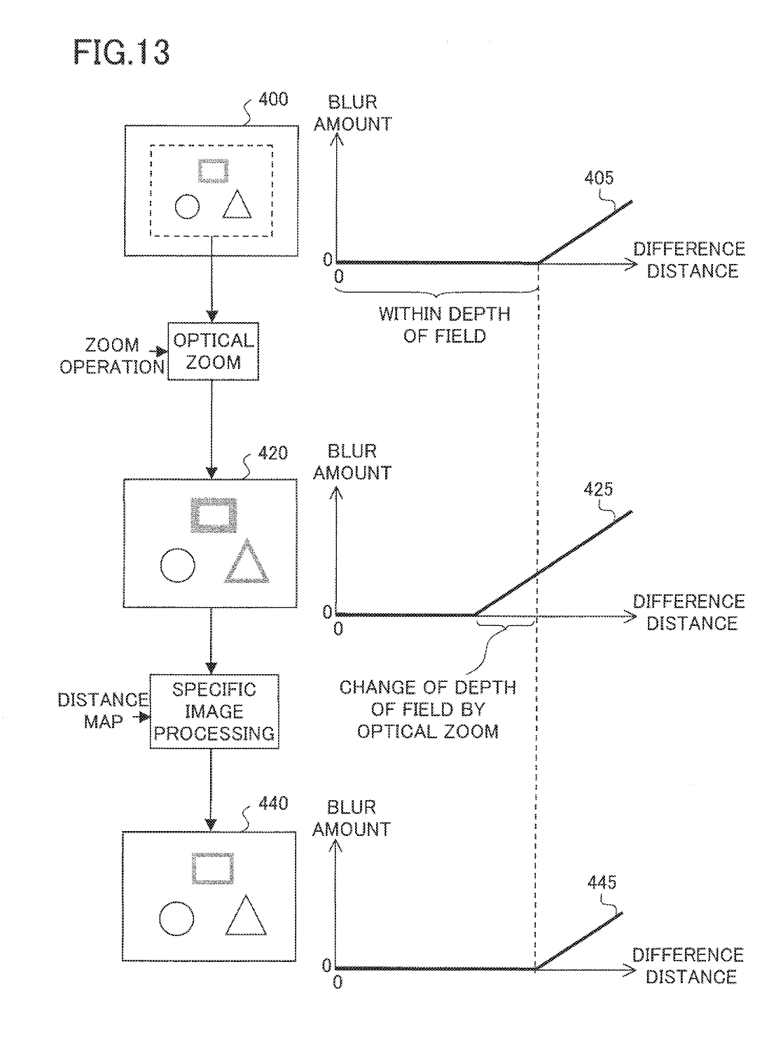

The change of the optical characteristic of the image pickup portion 11 along with an increase of the optical zoom magnification makes the depth of field of the input image 420 shallower than the depth of field of the input image 400. A bent line 425 of FIG. 11B indicates a relationship between a blur amount and a difference distance of each subject in the input image 420. Note that FIG. 13 illustrates the input image 400 and the bent line 405 of FIGS. 5A and 5B, the input image 420 and the bent line 425 of FIGS. 11A and 11B, and the focused state adjusted image 440 and a bent line 445 described later, in an integrated manner. FIG. 13 illustrates a flow of action in the special photographing mode.

In FIG. 11B, as described above, the distance DIF_{O} is equal to a half of the magnitude of the depth of field in the input image 400 and is equal to the difference distance DIF₄₀₂. On the other hand, the distance DIF_{S} is a half of the magnitude of the depth of field in the input image 420. Because the depth of field of the input image 420 is shallower than the depth of field of the input image 400, DIF_{S}<DIF_{O} is satisfied. As a result, the subject 402 that is a focused subject in the input image 400 becomes an out-of-focus subject in the input image 420. A blur amount of the subject 402 in the input image 420 is denoted b symbol Q₄₀₂. In addition, a blur amount of the subject 403 in the input image 420 is denoted by symbol Q₄₀₃. Because DIF₄₀₂<DIF₄₀₃ is satisfied, Q₄₀₃>Q₄₀₂>0 is satisfied, and the subject 403 is an out-of-focus subject in the input image 420, too. In addition, because of a change of the optical characteristic of the image pickup portion 11 along with an increase of the optical zoom magnification, the blur amount Q₄₀₃ of the subject 403 in the input image 420 is larger than the blur amount P₄₀₃ of the subject 403 in the input image 400 (see FIGS. 11B and 9). Because it is supposed that the distance Lo of the input image 420 is equal to the subject distance d₄₀₁, the subject 401 is a focused subject in the input image 420, too.

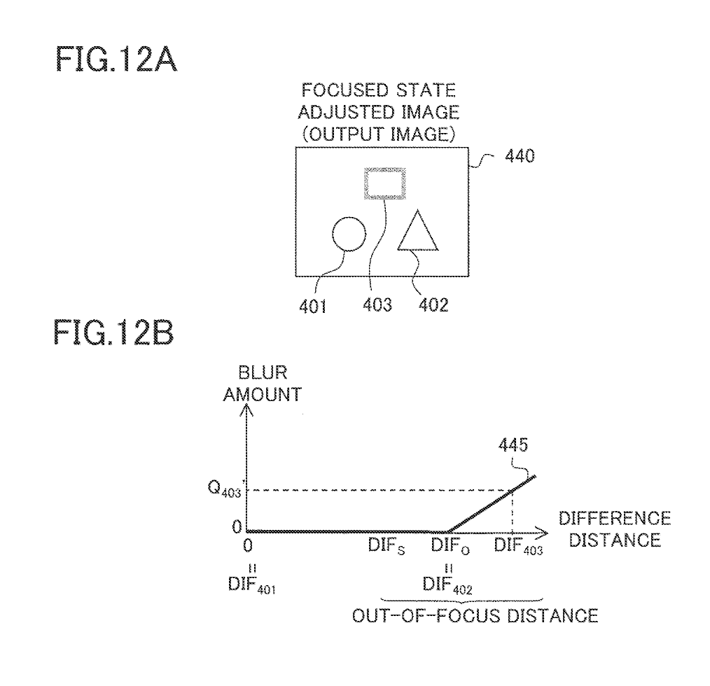

The focused state adjusting portion 57 can perform the specific image processing on the input image 420 obtained after changing the optical zoom magnification. FIG. 12A illustrates the focused state adjusted image 440 obtained by performing the specific image processing on the input image. The bent line 445 of FIG. 12B indicates a relationship between the blur amount and the difference distance of each subject on the focused state adjusted image 440.

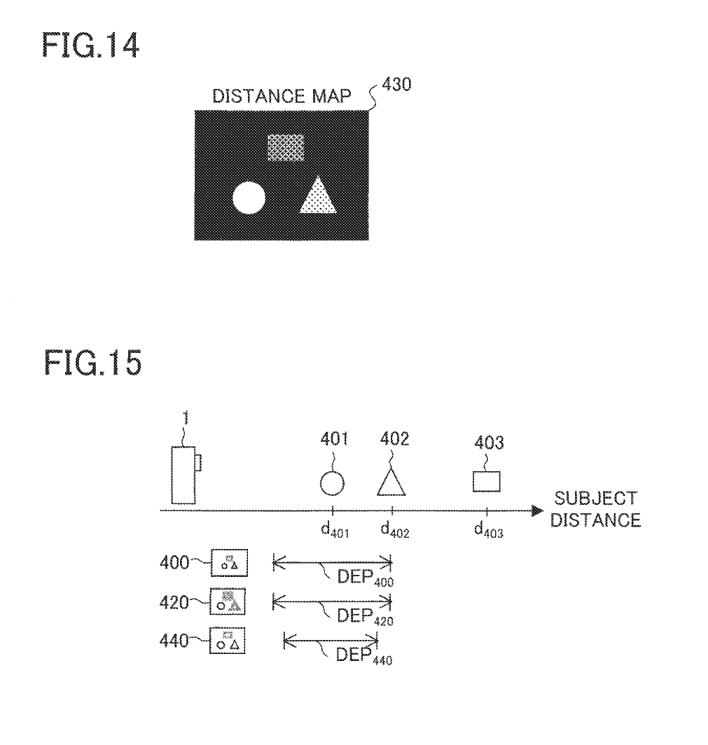

The adjusting portion 57 enlarges the depth of field of the input image 420 by the specific image processing using the distance map for obtaining the image 440 (namely, it increases the magnitude of the depth of field of the input image 420). The distance map that is used for the specific image processing performed on the input image 420 may be the distance map obtained by extracting an angle of view portion of the input image 420 from the distance map 410 of FIG. 6, or may be a distance map 430 obtained by performing the subject distance detecting process when the input image 420 is photographed (see FIG. 14). The distance map 430 is a distance map corresponding to the angle of view of the input image 420.

FIG. 15 illustrates a relationship of the depth of field among the images 400, 420, and 440. In FIG. 15, ranges DEP₄₀₀, DEP₄₀₂, and DEP₄₄₀ indicate distance ranges of the depth of field of the images 400, 420, and 440, respectively. Ideally, for example, the depth of field of the image 420 is enlarged by the specific image processing so that the depth of field in the image 440 agrees with the depth of field of the image 400. The agreement of the depth of field between the images 400 and 440 means that the distance Lo as well as the depth M_{DEP} is the same between the images 400 and 440. Therefore, in FIGS. 12A and 12B corresponding to ideal examples, the distance Lo is the same as the subject distance d₄₀₁ in the image 440, too. In addition, in FIGS. 12A and 12B corresponding to ideal examples, a half of the magnitude of the depth of field in the image 440 is the same as that of the input image 400, which is DIF_{O}, and DIF_{O}=DIF₄₀₂<DIF₄₀₃ is satisfied in the image 440. Therefore, in the image 440, similarly to the input image 400, the subjects 401 and 402 are focused subjects while the subject 403 is an out-of-focus subject.

In addition, along with enlargement of the depth of field, the blur amount Q₄₀₃′ of the subject 403 in the image 440 is smaller than the blur amount Q₄₀₃ of the subject 403 in the input image 420 (see FIGS. 11B and 12B). Ideally, for example, it is preferred to perform the specific image processing so that the bent line 445 of FIG. 12B becomes the same as the bent line 405 of FIG. 5B (see also FIG. 13), namely so that a relationship between the blur amount and the difference distance of each subject becomes the same between the images 400 and 440.

When the optical zoom magnification is Changed between the time points t₂ and t₃ (see FIG. 10), in response to the change, the selecting portion 58 of FIG. 4 selects not the input image 420 but the focused state adjusted image 440 at the time point t₄ so as to output the focused state adjusted image 440 as an output image. Thus, as illustrated in FIG. 10, a change of the focused state of the input image caused by a change of the optical zoom magnification is suppressed in the output image. In other words, the change of the depth of field of the input image sequence caused by the change of the optical zoom magnification is suppressed in the output image sequence. The image sequence means a set of a plurality of still images arranged in time sequence. The input image sequence here is constituted of a plurality of input images including the input images 400 and 420, and the output image sequence here is constituted of a plurality of output images including the output images 400 and 440.

Here, although not noted above, the action described above is useful in particular if the user issues the set instruction of the designated depth of field. The designated depth of field means user's desired depth of field that is designated by the user. The user can perform the set instruction of the designated depth of field (hereinafter referred to also as a depth set instruction) by the predetermined depth setting operation performed on the UI 52. The focused state setting operation described above is one type of the depth setting operation.

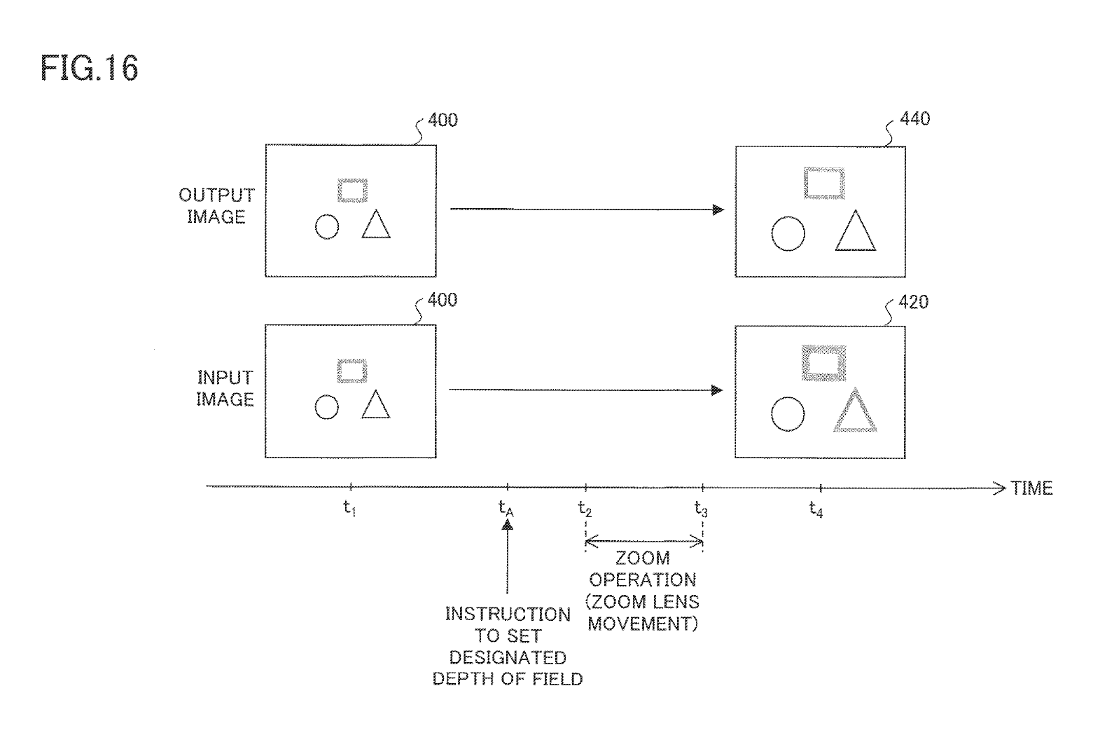

FIG. 16 illustrates an example of a relationship among the time point t_{A} when the depth set instruction is issued and the time points t₁ to t₄. As illustrated in FIG. 16, a time point after the time point t₁ and before the time point t₂ is supposed as the time point t_{A}. The user's desired focus reference distance Lo and the magnitude of the depth of field M_{DEP} designated by the depth set instruction are held as Lo′ and M_{DEP}′ in the data holding portion 61 of FIG. 4 at the time point t_{A}. In the example of the images 400, 420, and 440, it is supposed that the user is satisfied with the distance Lo and the depth M_{DEP} in the input image 400, and that the user instructs by the depth setting operation to hold the distance Lo and the depth M_{DEP} in the input image 400 as the Lo′ and M_{DEP}′ in the data holding portion 61.

After the user designates a desired depth of field by the above-mentioned depth setting operation, the user may perform the zoom operation to adjust a photographing composition. In this case, it is not preferred that the depth of field of the output image be changed from the one designated by the user due to execution of the zoom operation. In this embodiment, when the zoom operation is performed after the depth setting operation, the specific image processing is performed on the input image so that the depth of field of the focused state adjusted image becomes a depth of field corresponding to a designated depth of field (ideally, so that the depth of field of the output image is equal to the designated depth of field), and the obtained focused state adjusted image is provided as the output image to the user. Therefore, the user's desired depth of field is completely or substantially maintained also after the zoom operation so that the user desire is satisfied.

Hereinafter, some examples on the basis of the above-mentioned action and structure are described. It is possible to combine a plurality of examples described later as long as no contradiction arises.

### First Example

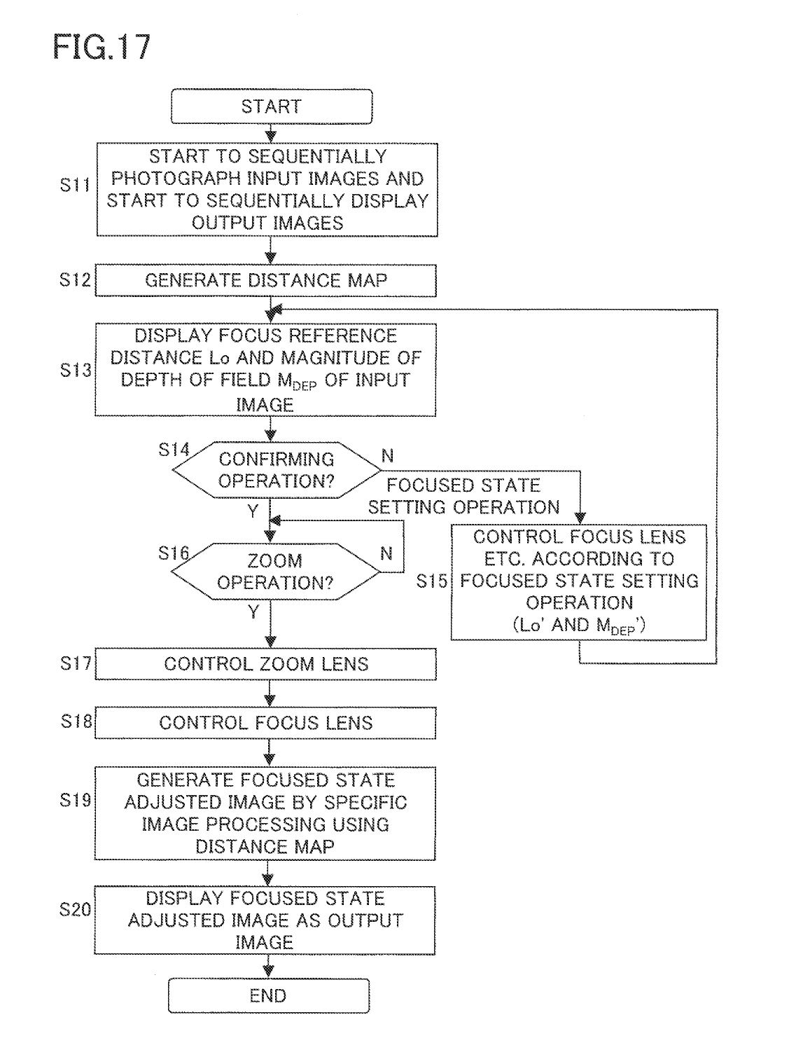

A first example is described. In the first example, an action procedure of the image pickup apparatus 1 is described with reference to FIG. 17 (see also FIG. 4). FIG. 17 is an action flowchart of the image pickup apparatus 1 in the special photographing mode.

When the action in the special photographing mode is started, sequential photography of input images and sequential display of output images are started in Step S11. The sequential photography of input images and the sequential display of output images are continued until the special, photographing mode is finished. A period for performing the process of Steps S11 to S18 corresponds to the period from the time point t₁ to just before the time point t₄, and a period for performing the process of Steps S19 and S20 corresponds to the period after the time point t₄ including the time point h (see FIG. 16). Therefore, in the period for performing the process of Steps S11 to S18, the sequentially photographed input images can be displayed sequentially as the output images.

After starting the sequential photography of input images, in Step S12, the subject distance detecting portion 54 of FIG. 4 detects the subject distance of a subject at each pixel of the input image at the present time point and generates the distance data so that the distance map generating portion 55 generates the distance map from the distance data. On the other hand, in Step S13, the main control portion 13 (for example, the focused state setting portion 56) determines the focus reference distance Lo and the magnitude of the depth of field M_{DEP} of the input image at the present time point from the basic focused state data with respect to the input image at the present time point. The determined distance Lo and depth M_{DEP} are displayed together with the input image at the present time point. The display of the Lo and M_{DEP} may be displayed as numerical values (for example, “Lo=5 m” and “M_{DEP}=3 m” are displayed), or icons or the like may be used for the display.

While the Lo and M_{DEP} are displayed, the image pickup apparatus 1 waits for user's confirming operation, in Step S14. If the displayed Lo and M_{DEP} match the user's desired focus reference distance and magnitude of the depth of field, the user can perform the confirming operation to the UI 52. Otherwise, the user can perform the focused state setting operation. If the confirming operation is performed, the Lo and M_{DEP} displayed in Step S13 are held as the Lo′ and M_{DEP}′ in the data holding portion 61, and the process goes from Step S14 to Step S16. If the focused state setting operation is performed, the process goes from Step S14 to Step S15.

As described above, in the focused state setting operation, the user can designate the Lo′ and M_{DEP}′ to be held in the data holding portion 61, and the Lo′ and M_{DEP}′ are output as the Lo* and M_{DEP}* from the focused state setting portion 56. In Step S15, the main control portion 13 (for example, the focused state setting portion 56) controls the focal length, the aperture stop value, and the like of the image pickup portion 11 by control of the focus lens 31 and the like so that the distance Lo and the depth M_{DEP} of the input image obtained by photography after the focused state setting operation respectively agree with Lo′ and M_{DEP}′ designated by the focused state setting operation (namely the Lo* and M_{DEP}*). After this control, the process goes back from Step S15 to Step S13, and the process of Steps S13 and S14 is repeated. When the process goes back to Step S13 via Step S15, the Lo and M_{DEP} displayed in Step S13 respectively agree with the Lo′ and M_{DEP}′ designated by the focused state setting operation.

The confirming operation functions as the depth setting operation for performing the set instruction of the designated depth of field as described above with reference to FIG. 16. The confirming operation without performing the focused state setting operation is a first depth setting operation, and the confirming operation after performing the focused state setting operation is a second depth setting operation.

The confirming operation in the first depth setting operation can be said to be an operation of designating that the depth of field of the input image obtained without the focused state setting operation should be maintained as the designated depth of field also in the subsequent photography. If continuing operation in the first depth setting operation is performed, the Lo and M_{DEP} of the input image obtained without the focused state setting operation are held as the Lo′ and M_{DEP}′ in the data holding portion 61 and are output as the Lo* and M_{DEP}*.

The confirming operation in the second depth setting operation can be said to be an operation of designating that the depth of field designated in the focused state setting operation should be maintained as the designated depth of field also in the subsequent photography if the confirming operation in the second depth setting operation is performed, the Lo′ and M_{DEP}′ designated in the focused state setting operation are held in the data holding portion 61 and are output as the Lo* and M_{DEP}*.

In Step S16, the users zoom operation is waited. When the zoom operation is performed, the process goes from Step S16 to Step S17, and the process of Steps S17 to S20 is performed.

In Step S17, the optical zoom magnification is changed by control of position of the zoom lens 30 in accordance with the zoom operation. Because the focus reference distance Lo of the input image is changed due to a change of the optical characteristic along with the change of position of the zoom lens 30, the main control portion 13 (for example, the focused state setting portion 56) performs control for canceling a Change in the focus reference distance Lo in Step S18. In other words, the main control portion 13 (for example, the focused state setting portion 56) controls the position of the focus lens 31 so that the focus reference distance Lo of the input image after the change of the optical zoom magnification agrees with the Lo′ (=Lo″) held in the data holding portion 61.

After that, in Step S19, the focused state adjusting portion 57 performs the specific image processing using the distance map on the input image at the present time point (the latest input image) so as to generate the focused state adjusted image. The generated focused state adjusted image is displayed as the output image in Step S20. The method of generating the focused state adjusted image is as described above. For instance (see FIG. 12A), if the input image at the time point when the confirming operation of Step S14 is performed is the input image 400, and if the input image on which the specific image processing is performed in Step S19 is the input image 420, the focused state adjusted image 440 is obtained in Step S19.

After the process of Steps S17 and S18, the process of Steps S19 and S20 can be performed every time when a new input image is obtained. Therefore, the specific image processing is performed sequentially on the input images obtained sequentially after the change of the optical zoom magnification, and hence the focused state adjusted image sequence obtained by the process can be displayed as the output image sequence. As described above, the image data of the arbitrary output image or output image sequence can be recorded in the recording medium 16.

Note that the distance map is generated between Steps S11 and S13 in the flowchart of FIG. 17, but it is possible to perform the specific image processing of Step S19 using the distance map generated after the process of Step S13 and before the process of Step S19.

According to the first example, the change of the depth of field accompanying the change of the optical zoom magnification is suppressed, and the user can get the output image having a desired focused state also after the change of the optical zoom magnification.

### Second Example

A second example is described. In the second example and later described third and fourth examples, the methods of the specific image processing are exemplified.

The specific image processing may be an image processing α₁ that can adjust the depth of field of the input image to an arbitrary depth of field. A type of the image processing α₁ is also called digital focus, and there are proposed various image processing methods as an image processing method for realizing the digital focus. A known method in which the depth of field of the input image can be adjusted to an arbitrary depth of field (for example, a method described in JP-A-2010-81002, WO06/039486 pamphlet, or JP-A-2009-224982) can be used as the method of the image processing α₁.

### Third Example

A third example is described. If the change of the optical zoom magnification is an increase of the optical zoom magnification, the specific image processing may be a sharpening process α₂ that is performed on pixels corresponding to the out-of-focus distance.

A specific method is described with reference to examples of the above-mentioned images 400, 420, and 440. After the optical zoom magnification is increased by the zoom operation after the input image 400 is taken, the input image 420 is obtained. The focused state adjusting portion 57 calculates difference distances of pixels of the input image 420 using the distances Lo* and DIF_{S}, and the distance map 410 or 430 (see FIG. 6 or 14), and classifies each pixel of the input image 420 into either one of the in-focus distance pixel and the out-of-focus distance pixel. In the third example, the in-focus distance pixels are pixels in which the image data of the focused subject on the input image 420 exists, namely pixels corresponding to the difference distance of the distance DIF_{S} or smaller. The out-of-focus distance pixels are pixels in which the image data of the out-of-focus subject on the input image 420 exists, namely pixels corresponding to the difference distance larger than the distance DIF_{S}. The adjusting portion 57 can recognize a value of the distance DIF_{S} from the basic focused state data (see FIG. 4) of the image pickup portion 11 when the input image 420 is photographed.

Here, in the same manner as supposed in FIG. 11B, it is supposed that the distance Lo* is the same as the subject distance d₄₀₁ (namely DIF₄₀₁=0 holds), and that the distance DIF_{S} is smaller than the distance DIF_{O} that is the same as the difference distance DIF₄₀₂. Then, among pixels of the input image 420, the pixels in which the image data of the subject 401 exists are classified into the in-focus distance pixels, and the pixels in which the image data of the subjects 402 and 403 exist are classified into the out-of-focus distance pixels.

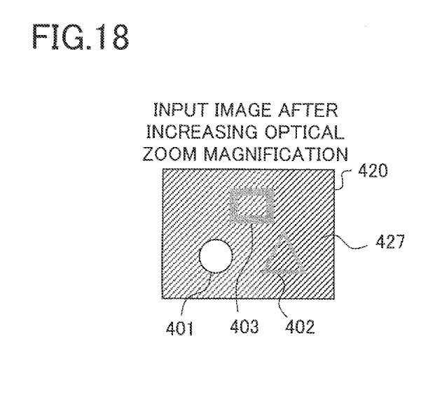

The adjusting portion 57 sets the image region constituted of all out-of-focus distance pixels as the process target region in the input image 420. In FIG. 18, a hatched region 427 indicates the process target region set in the input image 420. The process target region 427 includes the image region in which the image data of the subjects 402 and 403 exist, but does not include the image region in which the image data of the subject 401 exists.

The adjusting portion 57 performs the sharpening process α₂ on the process target region 427 of the input image 420 so as to generate the focused state adjusted image. In other words, the sharpening process α₂ is performed for sharpening the image in the process target region 427 of the input image 420, and the input image 420 after the sharpening process α₂ is generated as the focused state adjusted image. The sharpening process α₂ can be realized by filtering using an arbitrary sharpening filter suitable for image sharpening, for example.

When the sharpening process α₂ is performed, a visual effect is obtained as if the blur amount of pixels in the out-of-focus distance is reduced. As a result, a visual effect can be obtained as if the depth of field is deepened. Ideally; a focused state adjusted image equivalent to the focused state adjusted image 440 is obtained by the sharpening process α₂ (it may be considered that the image 440 is obtained by the sharpening process α₂). If the image processing α₁ of the second example is used for the specific image processing, the true depth of field of the input image can be enlarged by the specific image processing. However, if the sharpening process α₂ of the third example is used for the specific image processing, an apparent depth of field of the input image is enlarged by the specific image processing (the image whose apparent depth of field is enlarged is the focused state adjusted image of the third example).

Before the optical zoom magnification is increased, the input image 400 can be displayed or recorded as the output image. After the optical zoom magnification is increased, the focused state adjusted image based on the input image 420 can be displayed or recorded as the output image. Therefore, by using the specific image processing as the sharpening process α₂, a change of the focused state of the input image due to an increase of the optical zoom magnification is suppressed in the output image. In other words, a change of the depth of field of the input image sequence caused by an increase of the optical zoom magnification is apparently suppressed in the output image sequence.

### Fourth Example

A fourth example is described. If the change of the optical zoom magnification is a decrease of the optical zoom magnification, the specific image processing may be a blurring process α₃ performed on pixels corresponding to the out distance.

The specific method is described with reference to an example of the above-mentioned input image 400. Although some parts are different from the situation illustrated in FIG. 10, it is supposed as follows in the fourth example. The input image 400 is taken at the time point t₁, and then the distance Lo and the depth M_{DEP} of the input image 400 are held as the distance Lo′ and the depth M_{DEP}′ in the data holding portion 61 by the set instruction of the designated depth of field (depth setting operation) at the time point t_{A}. Further, afterward, between the time points t₂ and t₃, the optical zoom magnification is decreased.

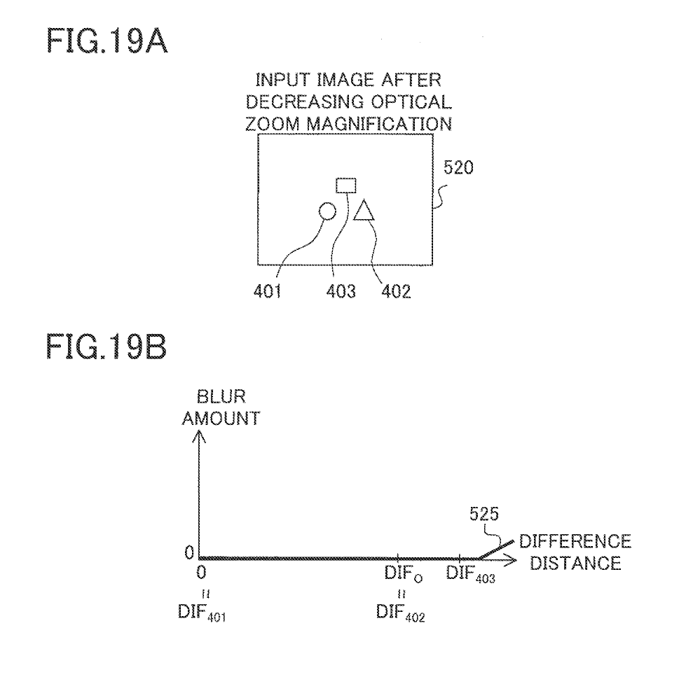

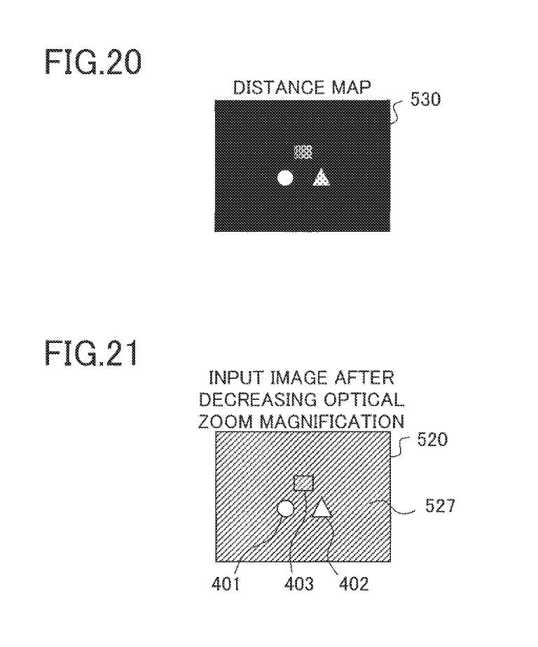

An image 520 of FIG. 19A is an input image Obtained at time point t₄, after the optical zoom magnification is decreased. A bent line 525 in FIG. 19B indicates a relationship between a blur amount and a difference distance of each subject in the input, image 520. The focus reference distances Lo in the input images 400 and 520 are both d₄₀₁. The depth of field of the input image 520 becomes deeper than the depth of field of the input image 400 because of the change of optical characteristic of the image pickup portion 11 accompanying a decrease of the optical zoom magnification. Here, it is supposed that all the subject distances d₄₀₁ to d₄₀₃ are within the depth of field in the input image 520 because of enlargement of the depth of field accompanying the decrease of the optical zoom magnification. FIG. 20 illustrates a distance map 530 obtained by performing the subject distance detecting process when the input image 520 is photographed. The distance map 530 is a distance map corresponding to the angle of view of the input image 520.

The adjusting portion 57 calculates the difference distance of each pixel of the input image 520 using the distance map 530 and the distance Lo* and the depth M_{DEP}* corresponding to the distance Lo′ and the M_{DEP}′, and classifies each pixel of the input image 520 into either one of the in-focus distance pixel and the out-of-focus distance pixel. In the fourth example, the in-focus distance pixels are pixels in which the image data of the focused subject on the input image 400 exists, namely pixels corresponding to the difference distance of the distance DIF_{O} or smaller. In the fourth example, the out-of-focus distance pixels are pixels in which the image data of the out-of-focus subject on the input image 400 exists, namely pixels corresponding to the difference distance larger than the distance DIF_{O}. As described above, it is supposed that the distance Lo and the depth M_{DEP} of the input image 400 are held as the distance Lo′ and the M_{DEP}′ in the data holding portion 61. Therefore, the distance DIF_{O} necessary for the classification is determined from the Lo′ and M_{DEP}′ (Lo* and M_{DEP}*).

The adjusting portion 57 sets the image region constituted of all the out-of-focus distance pixels as the process target region in the input image 520. In FIG. 21, a hatched region 527 indicates the process target region set in the input image 520. The process target region 527 includes the image region in which the image data of the subject 403 exists, and does not include the image region in which the image data of the subjects 401 and 402 exist.

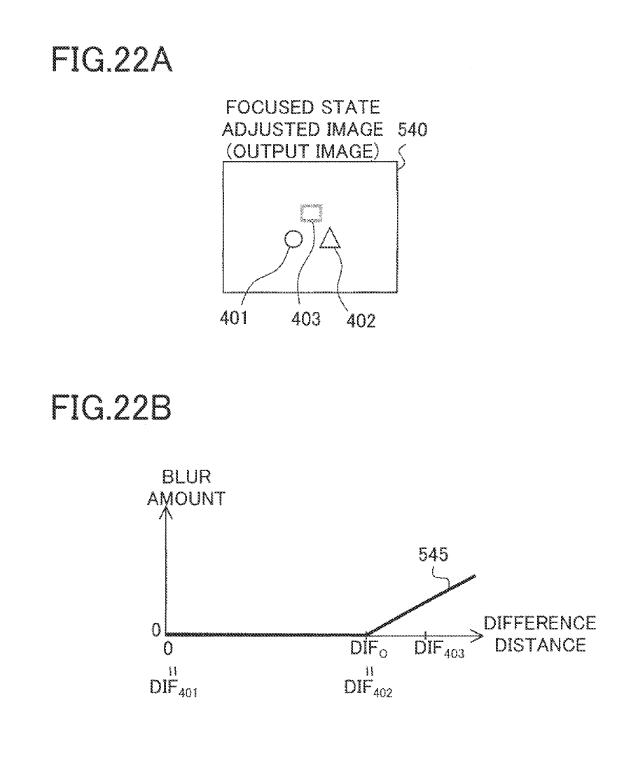

The adjusting portion 57 generates a focused state adjusted image 540 (see FIG. 22A) by performing the blurring process α₃ on the process target region 527 of the input image 520. In other words, the blurring process α₃ for blurring the image in the process target region 527 of the input image 520 is performed, and the input image 520 after the blurring process α₃ is generated as the focused state adjusted image 540. The blurring process α₃ can be realized by filtering using an arbitrary smoothing filter (such as a Gaussian filter) suitable for blurring an image, for example.

A bent line 545 in FIG. 22B indicates a relationship between a blur amount and a difference distance of each subject on the focused state adjusted image 540. Because the blurring process α₃ is simply performed on the out-of-focus distance pixels, the focus reference distance Lo is not changed between the images 520 and 540. However, because the blurring process α₃ is performed on the pixels corresponding to the difference distance larger than the distance DIF_{O} (namely out-of-focus distance pixels), the depth of field of the focused state adjusted image 540 is shallower than the depth of field of the input image 520. Ideally, the depth of field of the image 540 is the same as the depth of field of the input image 400.

Before the decrease of the optical zoom magnification, the input image 400 can be displayed or recorded as the output image. After decreasing the optical zoom magnification, the focused state adjusted image 540 based on the input image 520 can be displayed or recorded as the output image. Therefore, by using the specific image processing as the blurring process α₃, the change of the focused state of the input image caused by the decrease of the optical zoom magnification is suppressed.

in the output image. In other words, the change of the depth of field of the input image sequence caused by the decrease of the optical zoom magnification is suppressed in the output image sequence.

(Variations)

The embodiment of the present invention can be modified appropriately and variously in the scope of the technical concept described in the claims. The embodiment is merely an example of the embodiment of the present invention, and the present invention and the meanings of terms of the elements are not limited to those described in the embodiment. Specific values exemplified in the description are merely examples, which can be changed to various values as a matter of course. As annotations that can be applied to the embodiment described above, Notes 1 to 3 are described below. The descriptions in the Notes can be combined arbitrarily as long as no contradiction arises.

[Note 1]

In the flowchart of FIG. 17, when the focused state setting operation is performed, the focus lens 31 or the like is actually controlled in Step S15 so that the depth of field conforming the focused state setting operation can be obtained in the input image. However, instead of this, it is possible to use the specific image processing in Step S15. In other words, for example, when the focused state setting operation is performed in Step S14, the focused state adjusted image having the depth of field conforming the focused state setting operation may be generated from the input image by the specific image processing, and an input of the user's confirming operation may be waited in a state where the generated focused state adjusted image is displayed (Step S14).

### [Note 2]

The image pickup apparatus 1 of FIG. 1 may be constituted of hardware or a combination of hardware and software. If the image pickup apparatus 1 is constituted using software, the block diagram of a portion realized by software indicates a functional block diagram of the portion. The function realized using software may be described as a program, and the program may be preformed by a program executing device (for example, a computer) so that the . . . function can be realized.

### [Note 3]

For instance, it is possible to consider as described below. The image pickup apparatus 1 can be considered to be equipped with an output image generating portion that generates an output image by adjusting the focused state (including the depth of field) of the input image by a specific image processing, and a subject distance information obtaining portion that obtains subject distance information indicating a subject distance of each pixel of the input image. Elements of the output image generating portion include the focused state adjusting portion 57 of FIG. 4, and may further include the selecting portion 58. Each of the distance data and the distance map described above corresponds to the subject distance information. The subject distance information obtaining portion is constituted to include at least one of the subject distance detecting portion 54 and the distance map generating portion 55 of FIG. 4.

What is claimed is:

1. An image pickup apparatus comprising:
an input image generating portion that generates an input image from an optical image of a subject entering through a zoom lens; and
an output image generating portion that generates an output image by adjusting a focused state of the input image by image processing when an optical zoom magnification is changed by a positional change of the zoom lens.

2. The image pickup apparatus according to claim 1, wherein when the optical zoom magnification is changed, the output image generating portion performs the image processing on the input image so that a change of the focused state of the input image caused by the change of the optical zoom magnification is suppressed in the output image.

3. The image pickup apparatus according to claim 1, further comprising a user interface for receiving an instruction to change the optical zoom magnification and an instruction to set a designated depth of field, wherein
when the optical zoom magnification is changed in accordance with the change instruction after the set instruction of the designated depth of field, the output image generating portion performs the image processing on the input image so that a depth of field of the output image becomes a depth of field corresponding to the designated depth of field.

4. The image pickup apparatus according to claim 1, further comprising a subject distance information, obtaining portion that Obtains subject distance information indicating a subject distance of each pixel of the input image, wherein
the output image generating portion performs the image processing using the subject distance information.

5. The image pickup apparatus according to claim 4, wherein when the optical zoom magnification is increased, the output image generating portion sets a process target region in the input image obtained after the optical zoom magnification is increased, based on the subject distance information, and performs a sharpening process for sharpening the process target region, as the image processing.

6. The image pickup apparatus according to claim 4, wherein when the optical zoom magnification is decreased, the output image generating portion sets a process target region in the input image obtained after the optical zoom magnification is decreased, based on the subject distance information, and performs a blurring process for blurring the process target region, as the image processing.
